(19) United States
(12) Patent Application Publication
(10) Pub. No.: US 2007/0172575 A1
(43) Pub. Date: Jul. 26, 2007

(54) NUTRITIOUS EDIBLE COMPOSITIONS HAVING ZERO DIGESTIBLE CARBOHYDRATES AND HIGH PROTEINS AND PROCESSES FOR MAKING SAME

(75) Inventor: Shamika Abhijit Gune, Sonora, CA (US)

Correspondence Address: Shamika Gune, 346 Morning Star Drive, Sonora, CA, 95370, US

(73) Assignee: Shamika Abhijit Gune, Sonora, CA (US)

(21) Appl. No.: 11/164,163

(22) Filed: Jan. 20, 2006

(51) Int. Cl. A23L 1/31

(52) U.S. Cl. 426/641; 426/643

(57) ABSTRACT

A nutritious, high protein, zero carbohydrate pasta or bread is formed by combining animal protein with a binder, wherein the binder comprises substantially no digestible carbohydrates. A preferred composition comprises fish protein combined with guar gum. In an embodiment, odor, taste, texture, and color modifying ingredients are added, including for example a plant protein, ethyl maltol, salt, egg white, calcium carbonate, glycine, and/or polyphosphate.

### BACKGROUND OF THE INVENTION

Obesity has been linked to many diseases, shortened lifespan, increased health care expense, and decreased quality of life. Exercise and a well balanced diet that minimizes carbohydrates and fat intake has widespread acceptance as a healthy way to lose weight or keep from gaining weight. The importance of ingesting substantial amounts of proteins has also been well proved. There are a plethora of fat free foods, and even a fat substitute that has zero fat. The focus has now turned to lowering carbohydrate intake as well as fat intake while consuming substantial amounts of proteins.

Carbohydrates are a group of chemical substances that include sugars, glycogen, starches, dextrins and celluloses, which are formed only of carbon, oxygen and hydrogen. Generally, the monosaccharides and disaccharides are most soluble and easiest to digest, whereas the polysaccharides have varying solubility and digestibility. Many food products are laden with monosaccharides and disaccharides, such as glucose, fructose, and sucrose, and with simple polysaccharides such as starch and glycogen, all of which are quickly converted to energy or to fat if taken in excess.

Those practicing the low carbohydrate diet lifestyle selectively consume foods that are either inherently low in carbohydrates or those that yield low amounts of digestible carbohydrates. Pastas, noodles and many other food items traditionally made from wheat flour, semolina or any other form of cereal or grain constitute a major part of the foods consumed by people on a daily bases. Such food items are high in carbohydrates and hence their use in the lives of those on the “low-carb diet” is fast diminishing. Low carbohydrate alternatives to such high carbohydrate foods are presently available in the market. Such low carbohydrate or “low carb products” (as they are popularly known) yield much lower amounts of carbohydrates as compared to their traditional counterparts. However many low carb products are not completely free of digestible carbohydrates, and often have tastes and textures that are very different from the high carb foods that they replace. Further, since foods such as pastas, pizza crusts, cakes and breads are often eaten in large quantities to get a satiated or full feeling, even low carb alternatives lead to relatively high carbohydrate intake. The term pasta generally refers to shaped and dried dough made from flour and water and sometimes egg, which is unleavened. As used herein, the term will also apply to leavened dough such as can be used in making pizza crusts, breads, cereals and cakes. While it is generally recognized that some carbohydrates are needed to avoid unhealthy zero-carbohydrate-diet side effects, it appears that intake of carbohydrates can be better regulated if not from a source such as pasta or bread which is consumed in large quantities.

Exemplary low carb products are DREAMFIELDS® pasta, which are manufactured by Dakota Growers Pasta Co. of North Dakota, USA. These pastas can be purchased online from Netrition.com. An exemplary formulation comprises enriched semolina [semolina, iron (in the form of ferrous sulfate), and B vitamins (niacin, thiamin mononitrate, riboflavin, folic acid)], fiber blend (inulin, guar gum, xanthan gum, carrageenan, pectin), sorbitol, wheat gluten, and potassium chloride. Another low carb product is sold under the KETO brand name from Vitacost.com and comprises soy protein isolate, wheat gluten, durum wheat semolina, egg albumin, carrageenan gum, salt, potassium sorbate, and folic acid. While some of these pastas have been successful in reproducing the flavor and texture of high carbohydrate pastas, they still contain a substantial percentage of digestible carbohydrates, and further it is desired to have a higher protein concentration.

U.S. Pat. No. 6,569,483 to Zhoungbogbo et al. discloses a high protein low carb product, which comprises a flour substitute composition that comprises at least 50% vegetable proteins and/or animal proteins and less than 5% of digestible carbohydrate. The compositions of Zhoungbogbo always contain carbohydrates because the fibers used therein contain digestible carbohydrates. Further, Zhoungbogbo et al. specifically require carbohydrate in their flour.

United States Patent Application 20050129823 by Dohl, Christopher T.; et al.; discloses a composition and method of making high-protein and low-carbohydrate food products using a combination of amylase resistant starches and proteinaceous ingredients, none of which are animal protein or fish protein in origin. Further they describe the product to be “low-carbohydrate” containing some amount of digestible carbohydrates.

United States Patent Application 20050013900 by Dohl, Christopher T.; et al. discloses a composition and method of making high-protein and low-carbohydrate food products using a combination of various proteinaceous ingredients, none of which are animal protein or fish protein in origin. Further they describe the products to be “low-carbohydrate” containing some amount of digestible carbohydrates. United States Patent Applications 20050037125, 20050031755, 20050031754, and 20050031756 by Maningat, Clodualdo C.; et al. disclose compositions and methods of making high-protein and reduced-carbohydrate food products using a combination of various proteinaceous ingredients, none of which are animal protein or fish protein in origin. Further they describe the products to be “reduced-carbohydrate” containing some amount of digestible carbohydrates.

United States Patent Application 20040224068 by Lee, Paul K. discloses high moisture, high protein, and high fiber soy-based pasta without carbohydrates from grains or tubers. None of the sources of protein are of animal or fish origin. United States Patent Application 20050048183 by Yagjian, Michael discloses low carbohydrate pasta containing some digestible carbohydrates. Further the source of proteins is not animal or fish in origin.

Thus, there is a need for zero digestible carbohydrate or substantially zero digestible carbohydrate replacements for the basic foods that make up a substantial portion of the daily diet of the world's population. For example, there is a need for nutritious pasta, bread, cake or other products that are typically manufactured from grain, vegetable and/or tuber flour that has zero digestible carbohydrates. Such edible zero digestible carbohydrate compositions should also be high in protein and fiber. The text of all patents and other documents referenced herein, including documents referenced within referenced documents, is hereby incorporated by reference as if same were reproduced in full below.

### SUMMARY OF THE INVENTION

The present inventions comprise a nutritious edible composition having zero digestible carbohydrate and preferably zero fat. In one aspect the present inventions are directed to an alimentary paste or flour product formed of an animal protein combined with a non-digestible binder, which can be formed into pasta or other extruded product, and used to make bread or other baked goods. In an embodiment of the present invention, an edible, zero digestible carbohydrate composition comprises animal protein and a binder, wherein the binder has no digestible carbohydrate. A preferred source of animal protein is from minced processed fish meat, for example surimi, prepared without the carbohydrate binders. A preferred binder is guar gum, which does not yield digestible carbohydrates. Egg white can also be used as a binder in addition to the plant binder to alter texture and taste. Texture, color, taste and smell can also be adjusted by addition of isolated soy protein (ISP), calcium carbonate, salt, and an odor and/or taste masking agent, such as but not limited to ethyl maltol. The preferred composition has zero digestible carbohydrate since carbohydrate sources such as the binder, e.g., guar gum, yield substantially zero digestible carbohydrates when consumed in quantities that would normally be expected in a typical large adult portion of pasta formed with the present invention.

Preferred compositions comprise from about 30% to about 60% by weight animal protein, wherein the animal protein preferably comprises fish protein, and about 0.5% to about 2.5% by weight guar gum.

Alternative compositions further comprise about 1% to about 4% by weight of bird egg protein, about 0.1% to about 2% by weight salt, about 0.1% to about 2% by weight calcium carbonate, about 0.1% to about 1% by weight glycine, about 0.05% to about 0.02% by weight polyphosphate, about 0.001% to about 0.01% by weight ethyl maltol, about 30% to about 40% by weight water, about 10% to about 25% by weight soy protein, and/or about 0.1% to about 0.4% by weight vegetable oil.

While the compositions of the present invention preferably have zero fat, in an embodiment a small percentage of “healthy” oil can be added to products of the present invention to better approximate the texture and taste of certain pastas formed of traditional high carbohydrate flour. Healthy oils include but are not limited to certain vegetable oils and olive oil. It is believed that adding oil to adjust taste and texture will not substantially interfere with weight loss benefits of the present invention as the percentage will be quite small compared to the quantity typically consumed. Nevertheless, it is contemplated that a calorie-free fat substitute that is capable of passing through the body without being digested can also be used (e.g., olestra).

The present invention and its various embodiments are more fully described below with reference to the following drawings.

### DESCRIPTION OF THE DRAWINGS

FIG. 1 illustrates an exemplary process of the present invention for producing an exemplary nutritious composition of the present invention having zero digestible carbohydrates and high proteins.

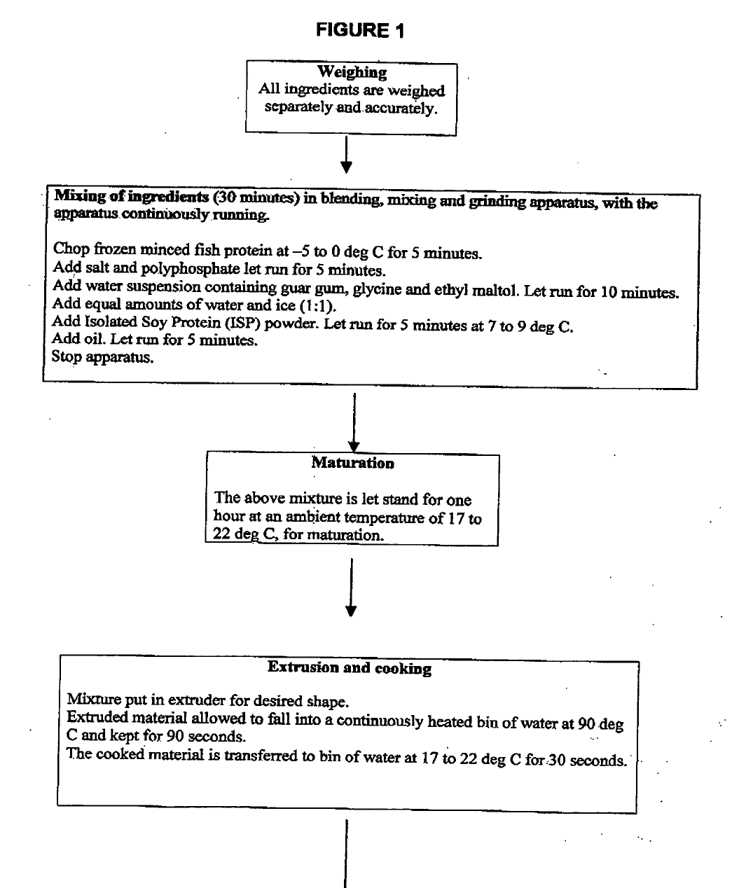

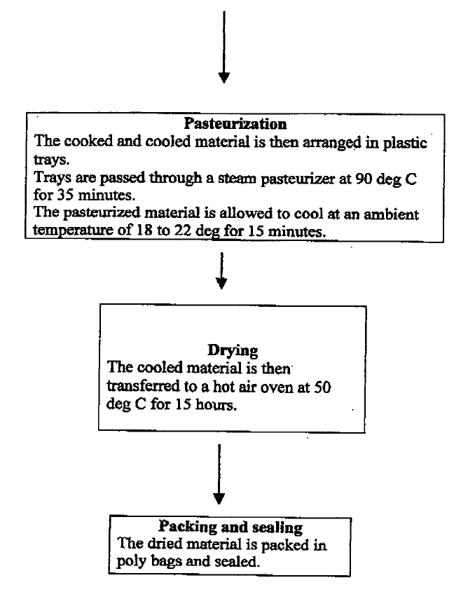

### FURTHER DETAILED DESCRIPTION OF THE INVENTION

Non-limiting examples of the present invention follow. In view of the advantages of the present invention, one of skill in the art will desire new foods to be prepared in accordance with and using the present invention.

Zero Carbohydrate Pasta Example 1

The following ingredients, in the quantities listed, were used to form zero carbohydrate pasta, following the exemplary process steps listed thereafter. By zero carbohydrate pasta, it is meant that the resulting composition has substantially zero digestible carbohydrates.

| Ingredient | Weight in gm | Weight in Kg | % by weight |
|---|---|---|---|
| Fish Protein | 450.00 | 0.45 | 39.674878 |
| Source (e.g., | | | |
| Surimi) | | | |
| Egg White | 30.0 | 0.03 | 2.6449918 |
| Salt | 13.5 | 0.0135 | 1.1902463 |
| Cal. Carbonate | 12.3 | 0.0123 | 1.0844467 |
| Glycine | 6.75 | 0.00675 | 0.5951232 |
| Polyphosphate | 1.629 | 0.001629 | 0.1436231 |
| Ethyl Maltol | 0.04 | 0.00004 | 0.0035267 |
| Guar gum | 17.00 | 0.017 | 1.4988287 |
| Water and Ice | 400.00 | 0.4 | 35.266558 |
| ISP | 200.00 | 0.2 | 17.633279 |
| Vegetable Oil | 3 | 0.003 | 0.2644992 |
| Total | 1134.219 | 1.134219 | 100 |

Procedure:

All ingredients were weighed separately and accurately.

Step 2: Chop frozen blocks of minced fish meat at −5 to 0 degree C. for 5 minutes using a surimi making machine and blender (a mixing & grinding apparatus).

Step 3: With the surimi making apparatus running, add salt and polyphosphate. The mixture may appear sticky. The apparatus is operated continuously for an additional 5 minutes.

Step 4: With the apparatus running, a water suspension containing guar gum, glycine and ethyl maltol is added, and the apparatus is run for 10 minutes more.

Step 5: With the apparatus running, water and ice in equal amounts (1:1) are added.

Step 6: With the apparatus running isolated soy protein (ISP) is added, and the apparatus is run for 5 minutes at 7-9 degree C.

Step 7: With the apparatus running, oil is optionally added, and the apparatus run for 5 minutes more before stopping the apparatus.

Step 8: The above mixture is kept for maturation for 1 hour at an ambient temperature of about 18-22 deg C.

Step 9: The mixture is put into an extruder, which will produce a desired extruded shape and extruded.

Step 10: The extruded material is allowed to fall into a bin of water held at 90 deg C., and cooked at this temperature for 90 seconds.

Step 11: The thus cooked material is then transferred to a bin of water at 18-22 deg C. for 30 seconds for cooling.

Step 12: The cooled material is arranged in plastic trays. The trays are passed through a steam pasteurizer at about 90 deg C. for about 35 minutes.

Step 13: The pasteurized material is allowed to cool at ambient temperature of about 18-22° C. for 15 minutes.

Step 14: The cooled material is transferred to a hot air oven for drying at about 50° C. for about 15 hours.

Step 15: At the end of the drying cycle the dried extruded material is packed in polybags and sealed.

Total time required for the above process is approximately 20 hours. One of skill in the art will appreciate that, depending on the scale of manufacture, pressures, temperatures, manufacturing equipment and other process steps will be optimized.

Cooking Instructions—

Bring water to a boil in a large pot. Add desired amount of the dried extruded product and cook for 8 minutes or until desired texture is reached. Turn off heat and let cooked product stand in the pot for 2 minutes. Drain 98% of the water the water, add preferred condiments and enjoy.

Cooked Product Characteristics:

On being fully cooked the product strongly resembles the traditional flour-based pasta. Such a resemblance is in the form of appearance (color, shape, etc), texture and most preferably taste. When compared to cooked “low carb pasta products” of the same shape, the product was much closer in resemblance to the traditional counterpart with respect to appearance, texture and shape than the former.

Breads and Cakes

It may be desired to have a porous or less dense final edible product using the food composition for of the present invention. This may be accomplished by combining sodium carbonate and/or sodium bicarbonate with a suitable acid (e.g., citric acid, etc.), and by the use of blowing or foaming agents.

Nutritional Analysis

Nutritional analysis of the above product was carried out by Geo-Chem, an international inspection and testing company. The results of the testing are provided in the table below.

NUTRITIONAL ANALYSIS OF ZERO CARBOHYDRATE PASTA
EXAMPLE 1

| | |
|---|---|
| MOISTURE | 9.50% |
| TOTAL FAT | 0.005% |
| SUGAR | NOT DETECTED |
| TOTAL CARBOHYDRATES | 7.80%** |
| PROTEIN | 73.80% |
| CRUDE FIBRE | 0.44% |
| CALORIES | 324 cal/100 gm |

**The 7.8% carbohydrates come from Guar Gum, which is a non-digestible gum classified as a carbohydrate. Since it is not digested when consumed and is excreted out, the above product yields zero digestible carbohydrates, or is a “zero carbohydrate” food.

### Preferred Ingredients

Without being limited to any particular theory of interaction or operation, preferred ingredients used in the formulation of Example 1 are discussed below. Minced Processed Fish Meat: Generally used in frozen form, but a fresh source could also be used. A preferred minced fish is called “surimi” in the eastern world. The minced meat is in the form of a paste that is rich in proteins. Almost any species of fish may be used for mince. Such fish can be but are not limited to Alaskan Pollock, Pacific Whitening, Japanese threadfin bream, and Ribbon Fish. Sugar or sorbitol is conventionally added to the minced fish as a cryopectant. The minced fish used in this invention is without such cryopectants or any other item that can yield any substantial digestible carbohydrates. Surimi can be obtained from Gadre Marine Export, 3298 A Mirkarwada, Ratnagiri 415612, Maharashtra, India.

Isolated soy protein (ISP): This is in the form of a powder. Its function is to impart “bite” or a “pasta-like” texture to the final product. Isolated Soy protein can be obtained from E.I. DuPont India P. Limited, DLF Plaza Tower, 8th Floor LF Qutab Enclave, Phase—I, Gurgaon 122 002, Haryana, India.

Egg white: Used in the form of a dry white powder. Functions as a binder, but also enhances protein content. An alternative protein binder can be used for a product for persons allergic to egg protein. Egg white can be obtained from Venkateshwara Hatcheries Private Limited, Egg Powder Division, Venkateshwara House, S. No. 114/A/2, Pune—Sinhagad Road, Pune—411030, Maharashtra, India.

Guar Gum: Guar Gum is a non-digestible fiber derived from the guar plant, native to India & Pakistan. It is used in the form of a food-grade powder. It functions as a binder, likely due to its water holding properties. Other edible binders can be used so long as they contain zero digestible carbohydrate. It is believed that other polysaccharides or other gums, such as xanthan and carrageenan (from seaweed) could be used in place of and/or in combination with guar gum in alternative formations to minimize digestible carbohydrates if not eliminate them, while optimizing taste, texture and costs. Guar Gum can be obtained from Altrafine Gums, 88/2, GIDC Estate, Phase—I, Vatva Ahmedabad—382445, Gujarat, India.

Ethyl Maltol: Used to mask fishy odor and taste. Used in the form of white crystals. Other taste and odor masking agents can be used as discussed below. Ethyl Maltol can be obtained from Dongyuan Chemical Co., Ltd of China. Other odor and taste masking agents may be used depending on the ingredients and intended use of the product. For example, pasta to be used in seafood dishes may need little if any masking. See below for suitable alternative masking agent candidates.

Salt: Food grade salt as per PFA standards. The salt may be white and granular or in powder form. Salt can be obtained from Tata Salt, Tata Chemicals, Bombay House, 24, Homi Mody Street, Fort, Mumbai—400 001, India.

Calcium Carbonate: Used in the form of white food grade powder, devoid of odor. It functions as a whitening agent, but can also modify texture and taste.

Polyphosphate: Functions as a refrigeration stabilizer and a water-retaining agent. Calcium carbonate and polyphosphate can be obtained from Famous Minerals and Chemicals Pvt Ltd, 507 Shreeji Arcade, Junction of SV Road and MG Road, Kandivali West, Mumbai, Maharashtra 400067, India.

Glycine: Yellow colored amino acid that functions as gel enhancer.

Oil: Used to alter texture and taste of product. A suitable oil can be obtained from Ganesh Oil Mill, Teli Ali, Ratnagiri, 415612, India.

Alternative Masking Agents

The table below demonstrates the masking effect of masking agents on fish oil that has both an unpleasant taste and an unpleasant odor. The compositions of the table were prepared by admixing various oil soluble masking agents with fish oil. The final compositions contained 5% masking agent.

| | |
|---|---|
| Boiling pt | Masking Effect |

| Masking Agent | degree C. | Odor | Taste |
|---|---|---|---|
| Benzaldehyde | 179 | Y | N |
| Orange Oil | 176 (1) | Y | N |
| Peppermint Oil | 216 (2) | Y | N |
| Spearmint Oil | 230 (3) | Y | N |
| Lemon Oil | 228 (4) | Y | N |
| Ethyl Maltol | — | N | Y |
| Ethylvanillin | 285 | N | Y |
| Vanillin | 285 | N | Y |
| Anethole | 236 | Y | Y |
| Dihydroanethole | 225 | Y | Y |
| Eugenol | 253 | Y | Y |
| Methyl Salicylate | 220 | Y | Y |

Y = Yes has a masking effect
N = No masking effect

Certain agents mask fish odor (e.g., benzaldehyde), others mask fish taste (e.g., ethyl maltol), and others, such as dihyrdoanethole and methyl salicylate mask both taste and odor. Anethole can be obtained from Gyan Flavours Export, Hari Chand Mela Ram Complex, Main Wazirabad Road East Gokul pur, Delhi—110094 (INDIA). Methyl salicylate can be obtained from Tripoot India Private Limited, A-88, Lajpat Nagar-Ilnd, New Delhi—110 024, (India)

Product Advantages

The invention comprises a composition for food products having zero digestible carbohydrates and at least 71% proteins per serving. Such products are meant to benefit those that aim to reduce the carbohydrate intake and increase the protein intake in their diets. Such people could be but are not limited to those practicing the Atkins diet, South Beach diet, diabetics and those that desire to lose weight by reducing the carbohydrate intake. Hence the present invention incorporates a new diet method, wherein the product of the present invention may be consumed to satiate a dieter's cravings for large traditional food servings and protein needs, and any vitamin, carbohydrate and other nutritional needs can be met by ingesting small quantities of supplements that can be readily regulated.

The products of the present invention have a high protein value. This value is higher than the protein content of the low carbohydrate products and traditional high carbohydrate products for which products of the present invention can substitute, e.g., pasta, noodles, breads, and cakes.

Some of the low carbohydrate pasta products currently available are known to have a “cardboard-like” taste and a rough texture, and are considerably dissimilar in taste and texture to those of the products they are intended to replace. In an aspect, the products of the present invention very closely resemble the taste and texture of the traditional food items, such as but not limited to pasta and breads.

The present pioneer invention has been described with reference to exemplary embodiments only, and incorporates by reference numerous teachings. Therefore, many variations to the disclosed embodiments are envisioned to be within the teachings and spirit of the present application.

What is claimed is:

1. A nutritious edible composition, comprising of an animal protein and a binder, wherein said composition comprises substantially zero digestible carbohydrate.

2. The composition of claim 1, wherein said animal protein comprises fish.

3. The composition of claim 2, wherein said binder is a plant gum.

4. The composition of claim 3, further comprises at least one of the group consisting of an odor masking agent, a taste masking agent, egg white, a colorant, a preservative, and a texturing agent.

5. The composition of claim 1, wherein said animal protein comprises fish, said binding agent is guar gum.

6. The composition of claim 1, comprising from about 30% to about 60% by weight animal protein, wherein said animal protein comprises fish, and about 0.5% to about 2.5% by weight guar gum.

7. The composition of claim 6, further comprising about 1% to about 4% by weight of bird egg protein, about 0.1% to about 2% by weight salt, about 0.1% to about 2% by weight calcium carbonate, about 0.1% to about 1% by weight glycine, about 0.05% to about 0.02% by weight polyphosphate, about 0.001% to about 0.01% by weight ethyl maltol, about 30% to about 40% by weight water, about 10% to about 25% by weight soy protein, and about 0.1% to about 0.4% by weight vegetable oil.

8. The composition of any one of claims 1-7, formed into a solid form which when cooked via boiling in water has the approximate texture and appearance of cooked pasta containing digestible carbohydrates.

9. The composition of any one of claims 1-7, further comprising of sodium carbonate and/or sodium bicarbonate with a suitable acid (e.g., citric acid, etc.) in appropriate amounts.

10. The composition of any one of claims 1-7, further comprising of blowing or foaming agents such as but not limited to baker's yeast in appropriate amounts.

11. The composition of any one of claims 1-7, further comprising of sodium carbonate and/or sodium bicarbonate with a suitable acid (e.g., citric acid, etc.); and blowing or foaming agents such as but not limited to baker's yeast in appropriate amounts.

12. The composition of any one of claims 1-7 and 9-11 when formed into a solid or semisolid form and cooked by baking has the approximate texture, taste and appearance of baked high carbohydrate breads and bread-like products.

13. The composition of any one of claims 1-7 and 9-11 when formed into a solid or semisolid form and cooked by application of heat through any medium has the approximate texture, taste and appearance of any high-carbohydrate food product traditionally made from tuber, root, grain, bean and/or cereal flours.

14. A diet method, comprising providing the composition of claims 1-7 and 9-11 to a dieter for consumption.

15. A method of preparing pasta comprising combining an animal protein with a binder, wherein the binder is substantially free of digestible carbohydrates.

16. A method of preparing bread or other products traditionally made from flour comprising combining an animal protein with a binder, wherein the binder is substantially free of digestible carbohydrates.

17. The method claim 14, wherein said animal protein comprises fish protein, and said binder comprises guar gum.
